(19) United States
(12) Patent Application Publication
(10) Pub. No.: US 2023/0280167 A1
(43) Pub. Date: Sep. 7, 2023

(54) A Method and Infrastructure for Communication of Perturbation Information in an Autonomous Transportation Network

(71) Applicant: DROMOS TECHNOLOGIES AG, München (DE)

(72) Inventor: Martin Dürr, München (DE)

(21) Appl. No.: 18/019,801

(22) PCT Filed: Aug. 3, 2021
(86) PCT No.: PCT/EP2021/071683

§ 371 Date: Feb. 4, 2023

(30) Foreign Application Priority Data
Aug. 4, 2020 (GB) 2012100.0

(51) Int. Cl. G01C 21/34; G08G 1/01; H04W 4/44

(52) U.S. Cl. CPC G01C 21/3415; G08G 1/0116; H04W 4/44

(57) ABSTRACT

A method of re-routing an autonomous vehicle operating on an initial pre-calculated route in an autonomous transportation network. The method comprises the detection of a perturbation regarding vehicle flow within a part of the autonomous transportation network by a first infrastructure element, the retrieval of at least one of a plurality of perturbation minimization strategies from a perturbation strategy memory based on the detected perturbation and the generation of perturbation information relating to the detected perturbation. The perturbation information or the perturbation minimization strategies are transmitted to at least one other infrastructure element in the autonomous transportation network and the perturbation information is transmitted from the one other infrastructure element to the autonomous vehicle. The autonomous vehicle follows an alternate pre-calculated route, wherein the alternate pre-calculated route is based on the received perturbation information.

### CROSS-REFERENCE TO RELATED APPLICATIONS

This application claims benefit of and priority to UK Patent Application No 2012100.0 filed on 4 Aug. 2020.

### FIELD OF THE INVENTION

The invention relates to a computer-implemented method of communication of perturbation information in an autonomous transportation network.

### BACKGROUND TO THE INVENTION

The term “automated transit network” or “automated transportation network” (abbreviated to ATN) is a relatively new designation for a specific transit mode that falls under the larger umbrella term of “automated guideway transits” (AGT). Before 2010, the name “personal rapid transit (PRT)” was used to refer to the ATN concept. In Europe, the ATN has been referred to in the past as “podcars”. This document sets out a method for improving the boarding process into an autonomous vehicle using the ATN.

Like all forms of AGT, ATN is composed of autonomous vehicles that run on an infrastructure network and are capable of carrying passengers from an origin to a destination. The autonomous vehicles are able to travel from an origin stop at the origin of the passenger’s journey to a destination stop at the destination without any intermediate stops or transfers, such as are known on conventional transportation systems like buses, trams (streetcars) or trains. The ATN service is typically non-scheduled, like a taxi, and travelers are able to choose whether to travel alone in the vehicle or share the vehicle with companions.

The ATN concept is different from self-driving cars which are starting to be seen on city streets. The ATN concept has most often been conceived as a public transit mode similar to a train or bus rather than as an individually used consumer product such, as a car. Current design concepts of the ATN currently rely primarily on a central control management for controlling individually the operation of the autonomous vehicles on the ATN. By comparison, self-driving cars are autonomous and rely on self-contained sensors to navigate.

A report on “Automated Transit Networks (ATN): A Review of the State of the Industry and Prospects for the Future” published by the Mineta Transportation Institute, Report No 12-31 in September 2014 reported that at the date of writing no ATN having more than ten stations had been implemented in the world. Currently the ATN networks operate on the principle of mapping each origin to all of the destinations. This leads to a matrix with 20 entries even for a simple five-station system as there are four possible destinations from each of the five origins. A ten-station system would have 90 possible routes and it will be seen that as the number of origins and destinations increases, then an O/D matrix listing all of the possible routes will expand out of hand. The current systems are therefore not scalable.

One of the issues that needs to be addressed in the autonomous transportation network is how to deal with perturbations in the network due, for example, due to closure of one part of the infrastructure in the autonomous transportation network or deadlocks in the infrastructure network because one part of the network is already occupied by other autonomous vehicles. Current solutions for dealing with perturbations involve the transmission of perturbation information relating to the perturbation to a central server. The central server calculates a new route for the autonomous vehicle avoiding the perturbation and this new route is sent back to re-program the autonomous vehicle along the new route. This re-programming is time consuming and requires substantial resources in the central server. The re-programming can also fail if the central server is unable to be reached. This is the approach adopted, for example, in UK Patent Application No. GB 2457927 (Advanced Transport Systems).

US 9478129 B1 describes a system for monitoring one or more vehicles using infrastructure elements located along a track. The infrastructure elements can communicate with one or more vehicles to sense the location and different conditions affecting the passage of the vehicles. Operation of the infrastructure elements as an intelligent mesh network is described. The system is also able to alert specific ones of the vehicles or other devices on the track regarding the sensed conditions and to influence vehicle controls such as steering. Data can be analyzed regarding traffic conditions and vehicle flow by transmitting the sensed information to a control management center.

US 9536425 B1 describes a system for increasing traffic carrying capacity of a road by varying number and width of lanes by using dynamically changing LED lane indicators. The system detects perturbations, such as slower vehicle speeds along a road segment, using infrastructure elements. The perturbation information is then processed and communicated to further ones of the infrastructure elements (intelligent lane markers) to adapt the number and width of lanes. Another embodiment of the application describes the creation of “virtual lanes” along which the vehicles travel instead of controlling by LED lane indicators.

US 2016/225253 A1 is directed to a system and method for providing vehicles with perturbation information, capable of effectively providing information about an accident on a road to vehicles driving toward the region where the accident has occurred, even during hours or in regions in which vehicle traffic is low.

US 2016/076207 A1 describes technologies for communicating perturbation information including a plurality of infrastructure elements configured to propagate communications amongst each other. Each infrastructure element is configured to transmit communications to one or more other infrastructure elements. The communications may include sensor data generated by a sensor of an infrastructure element. One or more of the infrastructure elements may transmit the sensor data to a roadway controller. Additionally, the infrastructure elements may communicate with a roadway controller, a roadway traffic device, and/or an in-vehicle computing system of a vehicle to propagate infrastructure element sensor data and/or alert messages. The roadway controller may be configured to control the roadway traffic devices, infrastructure elements, and/or communicate with remote computing devices.

US 2019/126958 A1 describes a method for detecting obstacles in a hazardous area in front of a rail vehicle which uses an obstacle detection arrangement to detect the obstacles. In order to permit improved autonomous driving of the rail vehicle, a target value is determined for a value which characterizes the performance of the obstacle detection arrangement. A system for detecting obstacles in a hazardous area in front of a rail vehicle is also provided.

WO 2017/054162 A1 describes an infrastructure element for monitoring and warning. The infrastructure element includes a processor, one or more sensors to sense motor vehicles and one or more alert strobes. The infrastructure element is to monitor sensor data generated by the one or more sensors and process the sensor data to detect a perturbation, determine a traffic state of a plurality of traffic states based at least in part on the sensor data and enable or disable one or more alert strobes based at least in part on the determined traffic state.

US 2017/300049 A1 describes a system for and method of controlling vehicles in a closed transport system. A closed transport system network controller generates a route for a requested journey and determines the commencement time of the journey from the origin point such that the vehicle executes the journey free of collisions with other vehicles in the closed transport system. The network controller provides steering and speed instructions in order for the vehicle to execute the route in the prescribed manner. The network controller controls all vehicles in the closed transport system such that, on a macro level, the capacity of the closed transport system is generally maximized.

### SUMMARY OF THE INVENTION

In order to overcome these limitations, a method of re-routing an autonomous vehicle operating on an initial pre-calculated route in an autonomous transportation network is taught in this document.

This method comprises detection of a perturbation regarding vehicle flow within a part of the autonomous transportation network by a first infrastructure element in the infrastructure network and retrieval of at least one of a plurality of perturbation minimization strategies from a perturbation strategy memory based on the detected perturbation. The method further comprises generation of perturbation information relating to the detected perturbation.

The perturbation information or the perturbation minimization strategy is transmitted to at least one other infrastructure element in the autonomous transportation network. The perturbation information is then transmitted from the at least one other infrastructure element to the autonomous vehicle. The autonomous vehicle then follows an alternate pre-calculated route. The alternate pre-calculated route followed by the autonomous vehicle is based on the received perturbation information.

The perturbation could be a blocked track in the infrastructure network, a potential or actual deadlock in the autonomous transportation network, or any other perturbation regarding vehicle flow due to other causes.

Additional perturbation minimization strategies can be retrieved from the perturbation minimization memory of the at least one other infrastructure element. The retrieval of the perturbation minimization strategies is based on the perturbation information transmitted to the at least one other infrastructure element. The perturbation information or the perturbation minimization strategies can be transmitted to at least one further infrastructure element connected to the at least one other infrastructure element. The at least one further infrastructure element transmits the perturbation information to the autonomous vehicle.

The retrieved perturbation minimization strategies define to which ones of the infrastructure elements the perturbation information or the perturbation minimization strategies are sent by the first infrastructure element. The perturbation information can also be transmitted to a central server.

The alternate pre-calculated route which the autonomous vehicle follows can be enabled by changing direction of travel along at least part of the autonomous transportation network.

The perturbation can also be detected by an autonomous vehicle which passes the information regarding the perturbation to the first infrastructure element.

The alternate pre-calculated routes or routing information can be generated by the autonomous vehicles, a central processor, or an infrastructure processor. The alternate pre-calculated routes or routing information can be transmitted to the autonomous vehicle.

The transmission of the perturbation information is carried out on communications links which link the infrastructure elements together and which could be wireless or cable networks. Unlike in the prior art, there is no need to pass the perturbation information to a central server for analysis and processing to enable the autonomous vehicles on the autonomous transportation network to change their routes dynamically whilst on the infrastructure network.

The infrastructure elements include a perturbation strategy memory which stores one or more pre-programmed perturbation minimization strategies which are accessed when one of the perturbations is detected to enable re-routing of the autonomous vehicles along alternate routings in the autonomous transportation network by coordinating infrastructure elements in the autonomous transportation networks. The perturbation minimization strategies are pre-programmed to enable rapid access and do not require re-calculation when the perturbation occurs. A re-calculation, even when done on fast processors, will take some time and will delay re-routing of the autonomous vehicles along the alternate routings. This could lead to some of the autonomous vehicles being snarled up at the perturbation. The pre-programmed perturbation minimization strategies can be time-dependent, weather-dependent or season-dependent. The pre-programmed perturbation strategies are reliable as they are tested regularly, generally error-free, and robust.

Further aspects of the method include transmission of the perturbation information to further infrastructure elements connected to ones of the previous infrastructure element and the subsequent infrastructure element. In other words, the perturbation information propagates throughout the infrastructure network to the different ones of the infrastructure elements present in the infrastructure network. This transmission is faster and saves computing resources at the central server. The different ones of the infrastructure elements will also have their own perturbation strategy memory with corresponding stored perturbation minimization strategies that are accessed.

It will be appreciated that it is possible for the generation of alternate routing information to be carried out by a least one of the autonomous vehicles, a central processor, or an infrastructure processor located at the infrastructure elements. The generation of the alternate routing information for the autonomous vehicle is most efficiently carried out in the autonomous vehicle itself which is supplied with a network map in a vehicle memory and details of the perturbation minimization strategy.

In addition to the generation of alternate routing information, other perturbation minimization strategies are possible. It would be possible, for example, to change the direction of travel along one or more lanes in multi-lane tracks or to slow the speed of the autonomous vehicles to ensure that there is a reduction of the number of autonomous vehicles at trouble spots, such as junctions or lane reductions.

This document also describes an infrastructure network with a plurality of tracks adapted for running of a plurality of autonomous vehicles in which the autonomous vehicles are operating on an initial pre-calculated route in the infrastructure network. As already noted, one of the reasons for a perturbation is that one or more of the plurality of tracks could be blocked. The infrastructure includes a plurality of infrastructure elements, connected by a plurality of communication links. These infrastructure elements include, but are not limited to, junctions, roundabouts, and other control points about the infrastructure network through which the autonomous vehicles can pass. At least one perturbation sensor is associated with ones of the plurality of infrastructure links, wherein the at least one perturbation sensor is adapted to identify perturbations in flow of ones of the plurality of autonomous vehicles on the plurality of tracks, and to generate perturbation information relating to the perturbation. This perturbation information is used as will be explained for accessing perturbation minimization strategies stored in a perturbation strategy memory associated with the infrastructure elements.

The infrastructure network will also comprise a plurality of beacons for communicating the perturbation information to ones of the plurality of autonomous vehicles. This perturbation information will come either directly from the autonomous vehicle, through the perturbation sensors, or from the infrastructure elements. The infrastructure network can further comprise a central server for receiving the perturbation information.

### DESCRIPTION OF THE FIGURES

FIG. 1 shows an overview of the autonomous transportation network.

FIG. 2 shows an example of an infrastructure network.

FIG. 3 shows the method for diversion of the autonomous vehicles due to a perturbation.

### DETAILED DESCRIPTION OF THE INVENTION

The invention will now be described on the basis of the drawings. It will be understood that the embodiments and aspects of the invention described herein are only examples and do not limit the protective scope of the claims in any way. The invention is defined by the claims and their equivalents. It will be understood that features of one aspect or embodiment of the invention can be combined with a feature of a different aspect or aspects and/or embodiments of the invention.

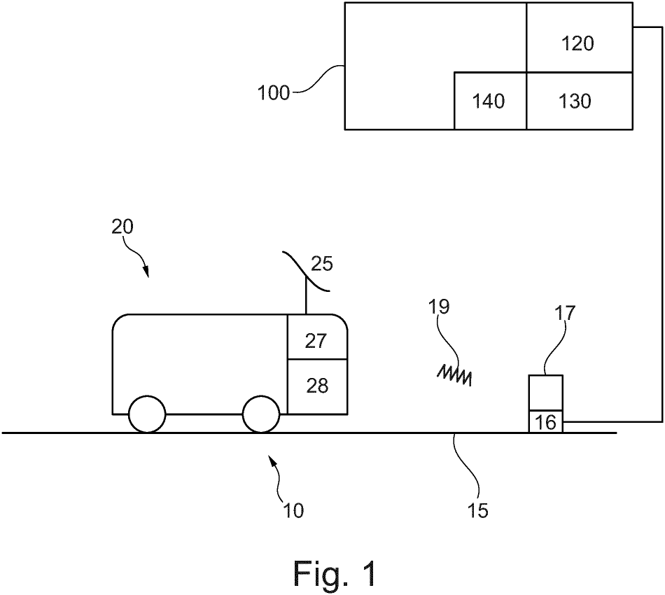

FIG. 1 shows an example of an autonomous transportation network 10 such as that described in the applicant’s co-pending UK Patent Application No. 20003395.7, the details of which are incorporated by reference into this application.

The autonomous transportation network 10 is an infrastructure network and has a plurality of autonomous vehicles 20 running on a plurality of tracks 15. The tracks 15 form a network of tracks over which the autonomous vehicles 20 are able to run. It will be appreciated that the tracks 15 may include guide rails, such as steel rails or concrete guidance elements, but could also comprise separated roadways. It is envisaged that the tracks 15 may be separate infrastructure or could also be incorporated into regular roadways and streets as long as sufficient safety measures are incorporated. The tracks 15 are provided with a plurality of beacons 17 (similar to rail balises) which monitor the progress of the autonomous vehicles 20 in the autonomous transportation network 10 and can also send signals 19 by wireless means to vehicles antennas 28 on the autonomous vehicles 20.

The autonomous vehicles 20 can be parked in a parking place with a plurality of tracks 15, be waiting at one or more stops 30 or in parking places or be in motion along the tracks 15. The autonomous vehicles 20 will be typically battery powered and can be charged, for example, when the autonomous vehicles 20 are in the parking places.

The autonomous transportation network 10 has a control management center 100 which monitors the progress of the autonomous vehicles 20 but does not directly control the progress of the autonomous vehicles 20. The autonomous vehicles 20 can send and receive information to the control management center 100, if necessary, and are connected to the control management center 100 through wireless connections using a vehicle antenna 28 located on the autonomous vehicle 20 in communication with the control management center 100 through the communications antenna 110 at the control management center 100. The control management center 100 is provided with a processor 120 and a central memory 140. The control management center 100 is connected to the beacons 17 using fixed communication lines 105 (although of course it would be possible to also use wireless connections over the distance between the beacons 17 and the control management center 100 or over part of the distance if required). The central memory 140 includes geographic data about the autonomous transportation network 10 including the location of the beacons 17.

A vehicle memory 25 in the autonomous vehicle 20 stores geographic data in the form of a network map with the locations of the plurality of stops 30 and also a selection of pre-calculated routes along the tracks 15 between any two of the stops 30. There will generally be more than one pre-calculated route between two of the stops 30 to allow for alternate paths or routes to be followed, if one of the pre-calculated routes is blocked or otherwise perturbed.

The autonomous vehicle 20 has not only the afore-mentioned vehicle antenna 28 and the vehicle memory 25 but will also include an onboard processor 27 which can control the autonomous vehicle 20 using the information in the vehicle memory 25 and any information received from the beacons 17.

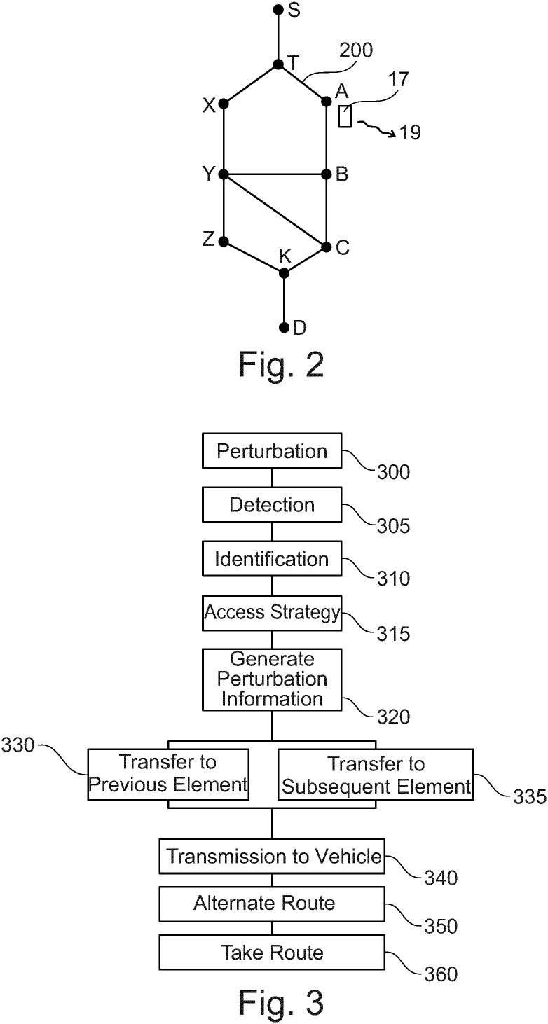

FIG. 2 shows an example of the transport infrastructure used by the autonomous transportation network 10. In this simple example there are multiple routes between a start point labelled S and a destination point labelled D. The autonomous vehicle 20 starts at the start point S and as noted above, has a variety of pre-calculated routes between the start point S and the destination point D stored in the vehicle memory 25. Suppose that the precalculated route (S-J-A-B-C-K-D) is from the start point S along way waypoints A, B and C to reach the destination point D. The autonomous vehicle 20 could equally well take the precalculated route (S-J-X-Y-K-Z) along way the waypoints X, Y and Z. The two routes divide out at a first junction J and join at a second junction K. There are also alternate direct routes between the waypoints B and Y and the waypoints Y and C, which could also be used by the autonomous vehicle 20. These alternate routes (termed S-J-A-B-Y-Z-K-D and S-J-X-Y-C-K-D) are known (or potentially known) to the autonomous vehicle 20 but the alternate routes are not preferred routes normally because the alternate routes are longer than the other two more direct routes. However, the alternate routes can be used if there is a perturbation or disturbance along part of the initially pre-calculated route, as will now be explained with respect to FIG. 3. This perturbation or disturbance could be a disruption in the flow of the autonomous vehicles 20 along the track 15 due to an obstacle, e.g., fallen tree, on the track 15 or a breakdown of one of the autonomous vehicles 20 on the track 15. One example of a breakdown could be an unexpectedly flat battery or a flat tire. The perturbation could also be due to a buildup of the number of the autonomous vehicles 20 along the route leading to potential delays or even deadlocks.

There are a number of infrastructure elements along the route which monitor the flow of the autonomous vehicles 20 along sections of the route using sensors and/or receive signals about perturbations from one or more of the autonomous vehicles 20. The infrastructure elements are connected to other ones of the infrastructure elements by communication connections 200, such as wireless connections or telecommunications cable. In general, each of the infrastructure elements will be connected using a telecommunications network (fixed-line or mobile) at least to the infrastructure element located previously in the route and to the infrastructure element located subsequently in the route, as is shown by the lines 200 on FIG. 2. Many of the infrastructure elements will be connected to more distant infrastructure elements. Suppose that the infrastructure elements are located at positions of the waypoints A, B, C and X, Y, and Z of the route shown in FIG. 2, then the infrastructure element at the waypoint A will be connected to the start S and the subsequent infrastructure element at the waypoint B. Similar the infrastructure element will be connected to the previous infrastructure element at the waypoint A as well as the subsequent infrastructure element at the waypoint C and also the subsequent infrastructure element at the waypoint Y, as there is also a route in the infrastructure network from the waypoints B to Y, as explained above. It would also be advantageous if the infrastructure element at the waypoint K were connected to the distal infrastructure element at the waypoint T to enable adjustments to the route of the autonomous vehicles 20 along either of the branches T-A-B-C-K or T-X-Y-Z-K. The connections between T and K should preferably be direct to avoid errors or delays in the transmission of the perturbation information due to hopping or daisy-chaining the information. This connection of the distal infrastructure elements enables the autonomous transportation network to act in a coordinated fashion. Some of the infrastructure elements can also be connected to a central server 100 by a communication connection.

The infrastructure elements also include a perturbation strategy memory 16 in which are stored a plurality of perturbation avoidance strategies. These perturbation minimization strategies are pre-programmed strategies that are implemented if a perturbation is detected in the autonomous transportation network 10. The perturbation minimization strategies can be hard-wired into the perturbation strategy memory 16 at the infrastructure element so that the perturbation minimization strategies are quickly and easily accessed if one or more perturbations are detected, or the perturbation minimization strategies could be stored in a solid-state memory, which is generally slower to access. The pre-programming of the strategies is done by computer modelling in advance and can later be adapted as experience is gained in the real-life operation of the autonomous transportation 10.

It will be appreciated that the perturbation minimization strategies are not “static”. The perturbation minimization strategies can depend on the time of day - for example a different strategy may be adopted during rush-hour periods - or day of week - on the weekends different strategies might be needed to cope with construction and repair work and/or due to fewer autonomous vehicles 20 on the network. The perturbation minimization strategies could be weather-dependent in which a different strategy is used during a rainy day in summer compared to a rainy day in winter with the risk of buildup of ice on the tracks 15.

The infrastructure elements will also include the beacon 17 which is able to communicate with the autonomous vehicles 20 and will pass the perturbation information about perturbations in the operation of the autonomous transportation network 10 to the autonomous vehicles 20 through the signals 19. An example of the beacon 17 emitting the signal 19 is shown associated with the waypoint A in FIG. 2, but it will be appreciated that other ones of the waypoints A, B, C, X, Y, and Z will have also beacons 17 associated with the waypoints. Additionally, the junctions at the waypoints J and K will also have beacons 17 which are not shown on the Fig.

The connections 200 between the infrastructure elements at the waypoints are also able to transfer the perturbation information and details of the perturbation minimization strategies between each other. This transfer of the perturbation information perturbation minimization strategies enables other ones of the infrastructure elements to access from their own perturbation strategy memory a corresponding perturbation minimization strategy and, if necessary, transfer the perturbation information and the perturbation minimization strategies to the autonomous vehicles 20 to enable the autonomous vehicles 20 to be re-directed to the alternate routes, e.g. S-J-A-B-Y-Z-K-D in the event that a perturbation is detected on the original route, i.e., S-J-A-B-C-K-D.

The manner in which the redirection happens will now by explained with reference to FIG. 3. Suppose that the autonomous vehicle is travelling from S to D along the route S-J-A-B-C-K-D and that a perturbation occurs in step 300 between the waypoints B and C. This perturbation can be detected by a perturbation sensor in step 305 either through the transmission of one of the signals 19 from one of the autonomous vehicles 20 travelling between B and C or by the infrastructure element at the waypoint C detecting that there are no autonomous vehicles 20 passing through the waypoint C. The waypoint C detects and identifies the perturbation in step 310 and in step 315 accesses the perturbation strategy memory. The perturbation strategy memory uses the perturbation information to access the pre-programmed perturbation minimization strategies in step 320.

One element of the perturbation minimization strategy might be to instruct the infrastructure element at B to transmit the perturbation information and/or the perturbation minimization strategy to one or more other infrastructure elements, e.g. the previous infrastructure element, i.e. at C, in the autonomous transportation network 10 in step 330 and also to the subsequent infrastructure element in step 335, i.e. C but also to the infrastructure element Y in the autonomous transportation network 10. Thus, both the previous infrastructure element A and the subsequent infrastructure elements C and Y know of the perturbation and will also know the perturbation minimization strategy generated in the infrastructure element B. Both the previous infrastructure element A and the subsequent infrastructure element C and Y can use the communicated perturbation information and the communicated perturbation minimization strategy to access their own perturbation memories to see if a relevant perturbation minimization strategy is stored.

In the case of the infrastructure element A, the perturbation minimization strategy might be, for example, to communicate the perturbation information back to the infrastructure element J so that no autonomous vehicles 20 are sent along the route J-A-B-C. The infrastructure element at the way point Y will know from the perturbation minimization strategy to expect vehicles along the route B-Y and also to expect more autonomous vehicles down the route J-X-Y-Z than would be normal.

The infrastructure elements at the waypoints J and B can then transmit in step 340 to any ones of the autonomous vehicles 20 passing through the waypoints J and B the information about the perturbation. The autonomous vehicles 20 can then in step 350 chose to take an alternate route (in this case through the waypoint Y from the waypoint B or through Y from the waypoint J). The alternate route will be stored in the vehicle memory 25 and thus the calculation will be simple. The autonomous vehicle 20 can alter its route in step 360 and rather than proceeding down the route J-A-B-C-K from the waypoint B to the waypoint C, the autonomous vehicle 20 will be directed to the waypoint Y along the alternate route, which will be either J-A-B-Y-Z-K or J-X-Y-Z-K.

As noted above, the perturbation information can be transmitted to further infrastructure elements connected to ones of the previous infrastructure element and the subsequent infrastructure element. In this manner, the waypoints along the route or routes that the autonomous vehicle 20 might take become aware of the perturbation and are able to signal to the autonomous vehicles 20 the alternate routes that the autonomous vehicles 20 should take. The perturbation information can also be transmitted to other infrastructure elements which are not connected to ones of the previous infrastructure element and the subsequent infrastructure element, but which have a direct connection to the transmitting infrastructure element. The perturbation information can also be transmitted to other infrastructure elements via the central server, given the transmitting infrastructure element as well as the receiving infrastructure element have a connection to the central server 100.

As regards the waypoint C, the infrastructure element knows that the direct route through the infrastructure network from B is perturbed. However, the infrastructure element at C is aware that there is an alternate routing from the waypoint B through the waypoint Y. The infrastructure element at the waypoint C knows of the perturbation and thus does not expect any of the autonomous vehicles 20 to arrive from the direct route from B, but knows that there is an alternate route through the waypoint Y. The infrastructure element at the waypoint C can then prioritize the acceptance of the autonomous vehicles 20 from the waypoint Y since these will be delayed autonomous vehicles 20 as these autonomous vehicles 20 are taking a longer route.

Other perturbation minimization strategies are possible in addition to the generation of alternate routing information. One further minimization strategy could be put in place at parts of the autonomous transportation network 10 where there are multiple parallel tracks 15 for the autonomous vehicles 20. Suppose, for example, there are three tracks 15. One of the tracks 15 could be used for the autonomous vehicles 20 travelling in a first direction and the other two tracks 15 could be used for the autonomous vehicles 20 travelling in the opposite (second) direction. Let us assume that there is a perturbation for those autonomous vehicles 20 travelling in the first direction. It is still possible for the autonomous vehicles 20 to continue on the routing, but there is a trouble spot ahead, for example, due to too many vehicles on the track 15 or a large number of extra vehicles joining at a trouble spot, such as a junction (shown for example at the waypoints Y and C in FIG. 2). In this case, one of the two tracks with the autonomous vehicles 20 travelling in the second, opposite direction, could be temporarily closed and freed of the autonomous vehicles 20, before switching the direction of travel of the autonomous vehicles 20 on the closed one of the tracks 15.

Generally, it would be useful to re-purpose the middle track of a three-track route. The example is not limited to three tracks but is equally applicable for four or more tracks.

Another perturbation minimization strategy would be to slow the speed of the autonomous vehicles 20 to ensure that there is a reduction of the number of autonomous vehicles 20 at trouble spots, such as junctions shown at the waypoints Y and C in FIG. 2. This could occur if a large number of the autonomous vehicles 20 attempted to merge at, for example, the waypoint C coming from the directions of the waypoint B and the waypoint Y and that this number of the autonomous vehicles 20 exceeded the capacity of the route from the waypoint C to the waypoint K. In this case, the autonomous vehicles 20 on the route C-K could be slightly accelerated and those autonomous vehicles 20 on the routes Y-C and B-C could be reduced in speed to avoid congestion at junction at the waypoint C.

The waypoint C will communicate the perturbation information through to the other waypoints Y and C who might also have their own perturbation minimization strategy to ensure, for example, that none of the autonomous vehicles 20 are sent along the route B-Y-C and that the autonomous vehicles 20 along the route X-Y are also slowed down.

In a further perturbation minimization strategy, two adjacent tracks 15 could be “entangled” with each other and the autonomous vehicles 20 could move from one of the tracks 15 to the adjacent one of the tracks 15 in a substantially real time manner to improve route capacity and thus reduce perturbations. The autonomous vehicles 20 travelling between any two of the waypoints could be informed that the autonomous vehicles 20 may switch tracks 15 as and when required between the two waypoints. There may also be instances in which the switching of tracks is not desired and in this case the autonomous vehicles 20 would receive a signal from, for example, the beacon 17, and be instructed to stay on the track 15 during the route.

Reference Numerals

| | |
|---|---|
| 10 | Autonomous transportation network |
| 15 | Tracks |
| 16 | Perturbation strategy memory |
| 17 | Beacons |
| 19 | Signals |
| 20 | Autonomous vehicles |
| 25 | Vehicle memory |
| 17 | Onboard processor |
| 28 | Vehicle antennas |
| 30 | Stops |
| 100 | Central management center |
| 105 | Communication lines |
| 110 | Communications antenna |
| 120 | Processor |
| 140 | Central memory |

1. A method of re-routing an autonomous vehicle operating on an initial pre-calculated route in an autonomous transportation network, the method comprising
detection of a perturbation regarding vehicle flow within a part of the autonomous transportation network by a first infrastructure element;
retrieval of at least one of a plurality of perturbation minimization strategies from a perturbation strategy memory based on the detected perturbation;
generation of perturbation information relating to the detected perturbation;
transmission of at least one of the perturbation information or the at least one of a plurality of perturbation minimization strategies to at least one other infrastructure element in the autonomous transportation network;
transmission of the perturbation information from the at least one other infrastructure element to the autonomous vehicle; and
following by the autonomous vehicle of an alternate pre-calculated route, wherein the alternate pre-calculated route is based on the received perturbation information.

2. The method of claim 1, further comprising:
retrieval of at least one of a plurality of perturbation minimization strategies from the perturbation strategy memory of the at least one other infrastructure element based on the perturbation information;
transmission of at least one of the perturbation information or the at least one of a plurality of perturbation minimization strategies to at least one further infrastructure element connected to the at least one other infrastructure element; and
transmission of the perturbation information from the at least one further infrastructure element to the autonomous vehicle.

3. The method of claim 1, wherein the retrieved at least one of a plurality of perturbation minimization strategies defines to which ones of the at least one infrastructure element the at least one of the perturbation information or the at least one of a plurality of the perturbation minimization strategies is sent by the first infrastructure element.

4. The method of claim 1, further comprising transmission of the perturbation information to a central server.

5. The method of claim 1, wherein the alternate pre-calculated route is enabled by changing direction of travel along at least part of the autonomous transportation network.

6. The method of claim 1, wherein the detection of the perturbation is from the at least one autonomous vehicle and is passed to the first infrastructure element.

7. The method of claim 1, wherein the generation of alternate routing information is carried out by at least one of the autonomous vehicles, a central processor, or an infrastructure processor.

8. The method of claim 7 comprising transmission of the alternate routing to the at least one autonomous vehicle.

9. An infrastructure network (10) comprising:
a plurality of tracks adapted for running of a plurality of autonomous vehicles (20) operating on an initial pre-calculated route in the infrastructure network;
a plurality of infrastructure elements, connected by a plurality of communication links;
at least one perturbation sensor associated with ones of the plurality of infrastructure links, wherein the at least one sensor is adapted to identify perturbations regarding the flow of ones of the plurality of autonomous vehicles (20) on the plurality of tracks, and to generate perturbation information relating to the perturbation; and
at least one perturbation strategy memory, wherein the at least one perturbation strategy memory stores a plurality of perturbation minimization strategies.

10. The infrastructure network of claim 9, further comprising a plurality of beacons for communicating the perturbation information to ones of the plurality of autonomous vehicles.

11. The infrastructure network of claim 9 further comprising a central server (100) receiving the perturbation information.
